(19) United States
(12) Patent Application Publication
(10) Pub. No.: US 2010/0211411 A1
(43) Pub. Date: Aug. 19, 2010

(54) SYSTEM AND METHOD FOR MATCHING USERS WITH A SERVICE PROVIDER, PROGRAM, OR PROGRAM SITE BASED ON DETAILED ACCEPTANCE CRITERIA

(75) Inventor: Courtney Hudson, Chapel Hill, NC (US)

Correspondence Address: Hanify & King Professional Corporation, 1055 Thomas Jefferson Street, NW, Suite 400, WASHINGTON, DC, 20007, US

(73) Assignee: EMERGINGMED.COM, New York, NY (US)

(21) Appl. No.: 12/772,786

(22) Filed: May 3, 2010

Related U.S. Application Data
(63) Continuation-in-part of application No. 09/699,372, filed on Oct. 31, 2000, now Pat. No. 7,711,580.

(51) Int. Cl. G06Q 50/00; G06Q 99/00; G06Q 10/00; G06F 15/16

(52) U.S. Cl. 705/3; 705/2; 705/317; 709/229

(57) ABSTRACT

A system and method for matching a user with service providers, at least one program offered by a service provider, and/or a program site for a program is provided. A user is prequalified if the user's profile satisfies acceptance criteria established for the service providers, at least one program offered by a service provider, and/or a program site. Once the user is prequalified, the user is given information to allow them to inform themselves about available service providers, programs offered by the service providers, or program sites and connect with the service provider, program, or program site. The present invention also envisions providing information about a user to at least one service provider, program offered by a service provider, or program site when the user satisfies specific acceptance criteria.

### CROSS-REFERENCE TO RELATED APPLICATIONS

This application claims the benefit of Utility Application No. 09/699,372 filed Oct. 31, 2000, the contents of which are incorporated herein in their entirety.

### BACKGROUND OF THE INVENTION

1. Field of the Invention

The present invention relates to a system and method for matching a user with a service provider, program offered by a service provider, or a program site for a program. More specifically, the present invention relates to a system and method for quickly and efficiently matching a user with a service provider, program offered by a service provider, or a program site for a program based on specific acceptance criteria.

2. Description of the Prior Art

Many service providers, such as providers of financial assistance, transportation assistance, social services, psycho-social services, fund raising services, case management services, and health/medical programs, products, tests, and procedures, require that users satisfy specific acceptance criteria in-order for the users to gain access to the respective service provider, a program offered by the service provider, or a program site where a program is being offered. For example, a health service provider, such as a clinical trial sponsor offers programs, such as clinical trials for new drugs, medical devices, therapies, or treatment programs. Typical clinical trial sponsors include pharmaceutical companies, biotech companies, medical device companies, clinical research organizations (CROs), and site management organizations (SMOs). Clinical trials are often an important step before obtaining FDA approval for particular drugs.

Individuals who have a need for access to a specific service provider, a program offered by a specific service provider, and/or a program site for a program often require assistance in quickly and efficiently identifying the appropriate service provider, program and/or program site for a program to meet their needs. For example, patients who have been diagnosed with a disease are often in need of finding appropriate clinical trials for new drugs, medical devices, procedures, diagnostic tests or treatment regimens to treat their disease. Patients with serious diseases may only have weeks or months to live or to make critical treatment decisions, and thus the ability to find available clinical trials and information about those trials quickly and efficiently is invaluable. Unfortunately today, there is no effective system for quickly matching users, such as patients, with appropriate services providers, such as a trial sponsor, or program, such as a clinical trial, or a program site, such as the location where an investigator offers the clinical trial.

Likewise, service providers often have difficulty identifying appropriate candidates/individuals to benefit from programs they offer, or the programs that are available at specific locations. For example, doctors are often not aware of all the clinical trials that are being performed in different geographic regions. Clinical Trial Investigators are often not aware of suitable patients within their own practices, health care network, or geographic region. Clinical trial sponsors have difficulty finding suitable patients for their trials because there is a lack of up-to-date listings of clinical trials, patients are geographically dispersed, many clinical trials require screening large segments of the population, a patient's suitability for a clinical trial may change over time, and patients lack insurance coverage.

What is needed is a method of quickly and efficiently matching qualified individuals, such as a user or patient, with appropriate service providers, programs offered by service providers, and/or programs offered at a program site, such as a trial sponsor, clinical trials or clinical trial site. What is also needed is a system that can match the individual/user's profile's personal information, such as a patient medical profile and patient characteristics, with acceptance criteria for a wide range of service providers, and programs offered by service provides, such as clinical trials in a defined or limited geographic area. For example, a user who resides in Ohio during summer and Florida during the winter may need to find service providers, programs, or program sites in both locations. What is also needed is a source of comprehensive information about service providers, programs and the like including, but not limited to, diseases, drugs, medical devices, tests, procedures, and clinical trials, to provide the necessary information to make informed decisions about a potential course of action, service providers, and programs offered by service providers.

### SUMMARY OF THE INVENTION

The present invention is a system and method for matching a user with at least one service provider, at least one program offered by a service provider, and/or a program site for a program, prequalifying the user for access to a service provider, at least one program offered by the service provide, and/or a program site, and providing information to the user to allow them to inform themselves about available service providers, programs offered by the service providers and connect with the service provider. The present invention also envisions providing information about a user to at least one service provider, program offered by a service provider, or program site when the user satisfies specific acceptance criteria. The method of the present invention comprises receiving user profile information for the user at a server connected to a computer network. The method also includes receiving, at a server, acceptance criteria pertaining to the service provided by the service provider and a series of targeted questions targeted to the service. A server compares the user profile information with acceptance criteria specifically developed for the program offered by the service provider or a group of service providers. The server determines whether the user prequalifies for any of the clinical trials, and notifies the user whether the user has prequalified for any clinical trials. Likewise, the service provider, program offered by a service provider or program to which the user is matched can also receive information about a user that satisfies specific acceptance criteria. Once the user has prequalified for a specific service, the user is provided with an application to authorize further follow-up in connection with the one or more service providers, at least one program offered by the one or more providers and/or a program site for an offered program.

In an embodiment of the present invention, a program includes, but is not limited to, a system of projects or services intended to meet a need, or offer a product, procedure, evaluation or test.

In an embodiment of the present invention, the user's profile is built by asking the user a series of questions and then building the user profile based on the user's responses, which is stored on the server. The questions can include static and dynamic questions. The user can also be asked a series of questions targeted to one or more service providers, at least one program offered by the one or more providers and/or a program site for an offered program after determining that the user meets the preliminary acceptance criteria for the one or more service providers, at least one program offered by the one or more providers and/or a program site for an offered program. The final determination of whether the user prequalifies is based on the user's response to the targeted questions or built user profile. When the user is provided with a question, the user is also provided with a set of answer options. The user responds to the question by choosing one or more of the answer options. Alternatively, the user can type in an answer to the question.

In an embodiment of the present invention, the user profile is built by using personal information for the user received from an external source. The personal information includes medical records, social services records, and publically available records. The personal information can be used to answer any of the series of questions to build the user profile, which is stored on the server.

In an embodiment of the present invention, service providers include trial sponsors, clinical trial investigators, financial assistance providers, case management providers, and social assistance providers.

In an embodiment of the present invention, the user includes a patient, individual in need of program assistance, family member, doctor or any health professional or allied health professional.

In an embodiment of the present invention, the program includes a clinical trial, an assistance program, and case management program.

In an embodiment of the present invention, the network includes the Internet, a private network and a combination thereof.

In an embodiment of the present invention, the acceptance criteria and the targeted questions can be received from an external source using a wired or wireless connection.

In an embodiment of the present invention, the acceptance criteria are received from an external source using a wired or wireless connection.

In an embodiment of the present invention, the external source includes a database, a system of the service provider, or a system of a third party that received acceptance criteria from a service provider.

In an embodiment of the present invention, the service provider includes a trial sponsor, investigator, financial services provider and the provider of any other service.

In an embodiment of the present invention, the service includes clinical trials for new drugs, medical devices, or treatments to treat their disease and financial services for new financial instruments, products and services or any other service or product provided by a service provider.

In an embodiment of the present invention, the user profile information includes patient information.

In an embodiment of the present invention, the user profile information is received from an external source. The external source includes, but is not limited to, a recordable storage medium storing the user profile information and a user terminal for entry of the user profile information.

In an embodiment of the present invention, the user profile information is stored in a recordable storage medium accessible by a server upon receipt of the user information from the external source.

In an embodiment of the present invention, once the user authorizes follow-up, the user is connected to the service provider including providing the user with contact information for the service provider or the service provider being provided with a mechanism to contact the user.

### BRIEF DESCRIPTION OF THE DRAWINGS

FIG. 1 depicts a block diagram illustrating the system of the present invention.

FIG. 1B depicts a block diagram of a server according to an embodiment of the present invention.

FIG. 2 depicts a flowchart illustrating a method of matching a patient with available clinical trial sites and prequalifying patients for clinical trials.

FIG. 3 depicts a block diagram illustrating some exemplary links between various records in data storage device 120.

### DETAILED DESCRIPTION OF THE INVENTION

The present invention is a system and method for matching a user with service providers, at least one program offered by a service provider, and/or a program site for a program, prequalifying the user for access to a service provider, at least one program offered by the service provide, and/or a program site, and providing information to the user to allow them to inform themselves about available service providers, programs offered by the service providers and connect with the service provider.

The method of the present invention comprises receiving user profile information for the user at a server connected to a computer network. The method also includes receiving, at a server, acceptance criteria pertaining to the service provided by the service provider and a series of targeted questions targeted to one or more service providers, programs offered by the one or more service providers, and/or program sites. A server compares the user profile information with acceptance criteria specifically developed for the program offered by the service provider. The server determines whether the user prequalifies for any of the clinical trials, and notifies the user whether the user has prequalified for any clinical trials. Once the user has prequalified for a specific service, the user is provided with an application to authorize further follow-up in connection with the one or more service providers, at least one program offered by the one or more providers and/or a program site for an offered program.

While the invention will be discussed in connection with an embodiment directed to the matching of patients to clinical trials, one having ordinary skill in the art would recognize that the steps describe herein are equally applicable to matching a user to one or more the service providers, programs offered by the one or more service providers, and/or program site of the service provider, products and goods offered by a service provider or organizational entity. Accordingly, the invention is not intended to be limited to the embodiment discussed herein.

In a preferred embodiment of the invention, the system resides on a server on a communications network, such as the Internet or a private network. Users of the system can conveniently access the system using a wired or wireless connection to the network. For example, users, service provider, and program sites, such as and trial sites, can access the system by visiting the EmergingMed.com web site.

In addition to matching users with service programs, programs offered by service providers and/or programs sites, the server of the present invention also allows users to search and view information about aspects of a program offered by a service provider, such as various diseases, drugs, medical devices, clinical trials, treatment programs, social assistance programs, financial assistance programs, case management programs, medical news, research and other similar sources of information. For example, patients who visit the EmergingMed.com web site can get educated on the disease for which they have been diagnosed and the available clinical trials. Health care professionals can also access the EmergingMed.com web site to learn the latest medical information. They can also learn about what various clinical trials are available for that disease, which trials are already closed (i.e., the sponsoring companies are not taking any more patients), and which trials are still open and taking patients.

Likewise, service providers often have difficulty identifying appropriate candidates/individuals to benefit from programs they offer, or the programs that are available at specific locations. For example, clinical trial sponsors, a type of service provider according to an embodiment of the present invention, include pharmaceutical companies, biotech companies, medical device companies, clinical research organizations (CROs), and site management organizations (SMOs). The EmergingMed.com web site benefits service providers, such as clinical trial sponsors, by allowing them to quickly find, prescreen and recruit suitable patients for their clinical trials. The EmergingMed.com web site thus allows the trial sponsors to accelerate the conduct and completion of their clinical trials in order to obtain FDA approval or demonstrate additional efficiency for particular drugs or devices. By accelerating the conduct and completion of clinical trials, these companies can effectively reduce costs and speed up time to market.

The individual or group of individuals who actually conduct a clinical trial for a sponsor will be referred to herein as an “investigator.” The investigator or investigators conduct clinical trials at clinical trial sites. For example, a drug company is interested in conducting trials for a new drug which it has just developed for fighting cancer. A doctor is conducting a clinical trial for the drug company at New York Hospital in New York. The drug company is the clinical trial sponsor. The doctor is the investigator. New York Hospital is the clinical trial site.

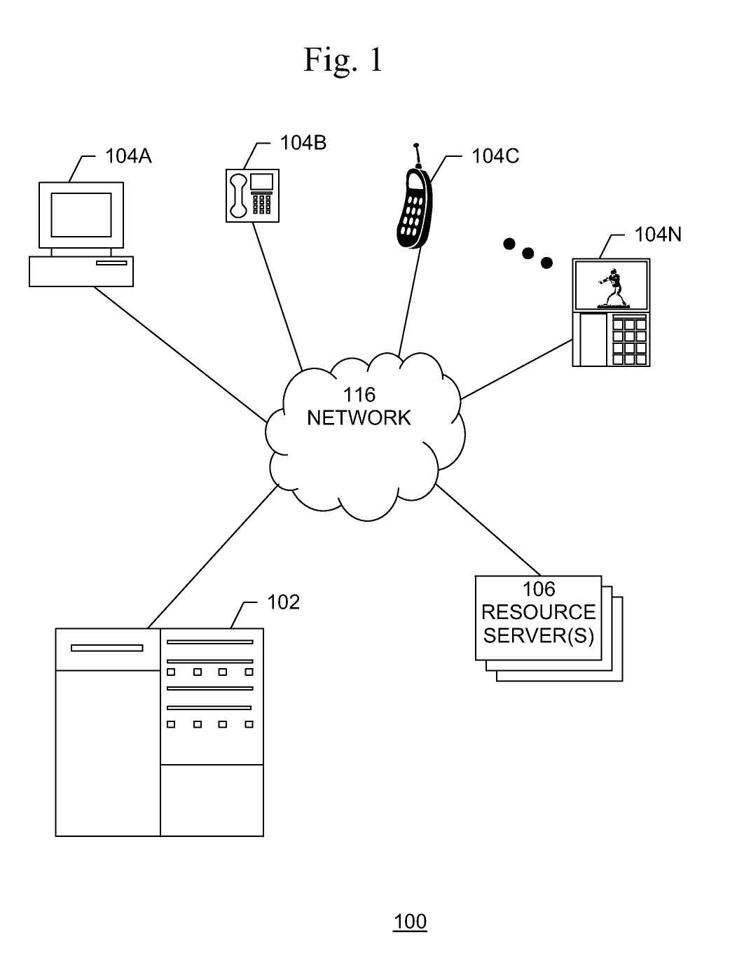

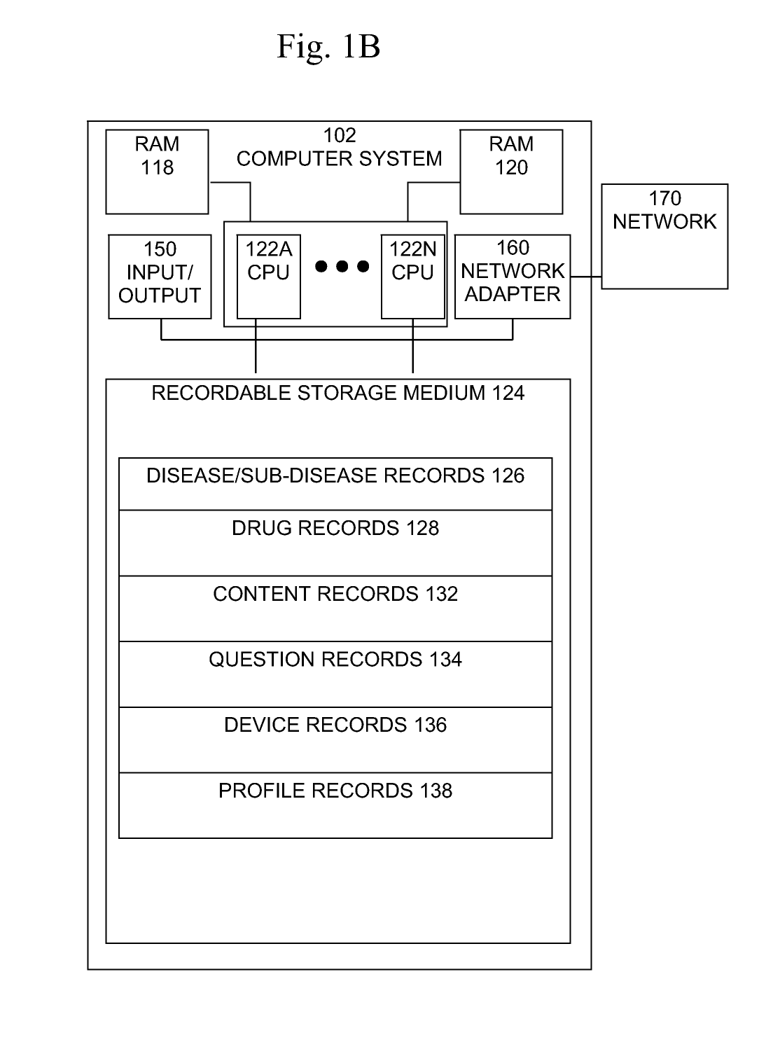

FIG. 1 depicts a block diagram illustrating the system of the present invention. FIG. 1 shows an EmergingMed.com server 102, a network 116, a plurality of end user devices 104A-N and resource servers 106. Network 102 typically is, or includes the Internet, but may include any communications network that is now in service or which may be developed in the future. Such a network may include one or more public or private communications networks, such as the Internet, wired or wireless telephone networks, wired or wireless data networks, local area networks, etc. End user devices 104A-N include any device capable of transmitting audio and/or data to and from an end user, such as a computer system 104A, an audio-only telephone 104B, such as a PSTN or IP phone, a mobile phone 104C, and a wireless computer 104N. End users, such as individuals, patients, family members, service providers and the like can use any end user device 104 to access EmergingMed.com server 102. Service providers include, but are not limited to, professionals, such as healthcare professionals, clinical trial investigators, doctors. Resource servers 106 are data sources of a service provider, user, or other party external to the EmergingMed.com server that contain data received by EmergingMed.com server 102, such as acceptance criteria, user information, provider information, built user profiles and questions including static, dynamic, general and targeted.

EmergingMed.com server 102 shown in FIG. 1B as system 200 includes a CPUs 122A-122N which is running a program which operates the method of the present invention. CPUs 122 accesses RAM 118, ROM 120, and recordable storage medium 124. Recordable storage medium 124 can be any magnetic or optical media, or any other medium for storing electronic data. As will be understood by one of skill in the art, EmergingMed.com server 102 can comprise multiple servers working together, and recordable storage medium 124 can similarly comprise multiple storage devices.

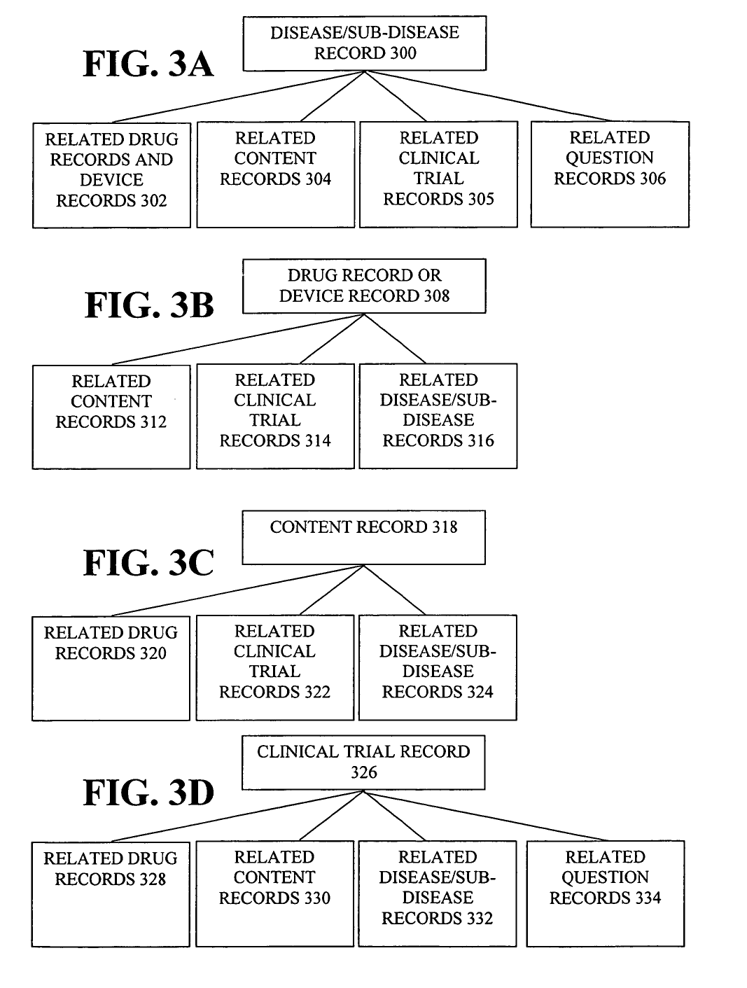

Recordable storage medium 124 contains a database 142. Database 142 contains information organized into records. Some exemplary records are shown in FIG. 1. One having ordinary skill in the art would recognize that each of the records described herein below are directed to an embodiment of the present invention directed to a health/medical service provider. Accordingly, the records and the data contained therein can be modified for specific service providers. In the FIG. 1 embodiment of the present invention the records are disease/sub-disease records. Disease/sub-disease records 126 contain information related to specific diseases. These records are organized both by disease and sub-disease. An example of a disease is “cancer” and an example of a sub-disease is “skin cancer.” Disease/sub-disease records 126 contain information about the disease such as description of the disease, symptoms, treatment, history, and other pertinent information. In an embodiment of the present invention, the information organized as records can include information related to products, services, goods and/or a combination thereof offered, promoted, or manufacture by an organizational entity. Each disease/sub-disease record 126 also includes links to other related records in database 142 such as drug records 128 (e.g. drugs used to treat the disease), content records 130, clinical trial site records 132, question records 134, and device records 136. The links between records are described in more detail with respect to FIG. 3.

In the FIG. 1 embodiment of the present invention, drug records 128 contain information about various drugs. Such information includes the purpose of the drug, compound name, generic name, brand names, instructions for taking the drug, warnings, side effects, and any other pertinent drug information. Each drug record 128 contains links to other records in database 142. In an embodiment of the present invention, records 128 can be records that contain information about a product, services, or good.

Content records 130 contain various kinds of content such as newspaper and journal articles, research reports, frequently asked questions, standard therapies, alternate medicine, case studies, and various other types of medical information that would be of interest to someone seeking information about diseases and treatments. Content records 130 contain links to other records in database 124.

In the FIG. 1 embodiment of the present invention, clinical trial site records 132 contain information pertaining to various clinical trial sites. Clinical trials are performed for various reasons such as to test the efficacy of a new drug, a new medical device, or a new therapy. Clinical trials are often performed prior to obtaining FDA approval. One clinical trial may take place at multiple clinical trial sites. Each clinical trial site preferably has its own record in clinical trial site records 132. A clinical trial is conducted by an investigator on behalf of a sponsor at a clinical trial site. In an embodiment of the present invention, records 132 contain information pertaining to various organizational entities providing good, services, products, and/or a combination thereof.

Clinical trial site records 132 contain information about the clinical trial site such as the sponsor's name and information, investigator's name and information, location, number of patients admitted, number of patients allowed, open or closed status, drug or device being tested, names of staff, duration of trial, phases of the trial, purpose of the trial, trial methodology, and any other information relevant to the clinical trial being performed. Clinical trial site records 132 contain links to other records in database 142.

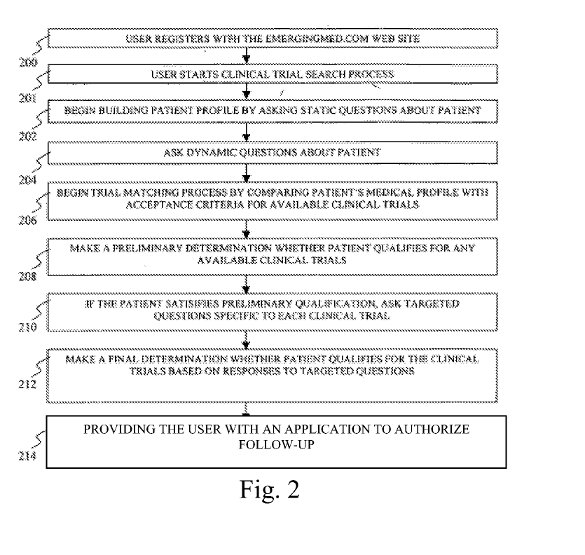

In the FIG. 1 embodiment of the present invention, question records 134 contain questions that are asked to users who are seeking to join clinical trials, purchase goods, and services offered by an organizational entity and like. As explained in detail with respect to FIG. 2, users who are seeking to join clinical trials are asked a series of questions about their disease, their prior treatment, and their medical history. The answers to these questions are used to build a user profile. If the answers to these questions match the acceptance criteria for a specific service, such as clinical trials, then the user is deemed a match and prequalifies for follow-up. Question records 134 contain links to other records in database 142.

Device records 136 contain information about various medical devices such as the device manufacturer name, the diseases and conditions treated, instructions for using the device, warnings, and other pertinent device information. Device records 136 contain links to other records in database 142.

User registration records 140 contain user information about the various users authorized to access EmergingMed.com server 102. User registration records 140 contain information such as user name, user ID number, login name, password, access privileges, customized user preferences, mail accounts, links to patient profiles, and any other similar user information.

In the FIG. 1 embodiment of the present invention, User profile records 138 contain various types of information about users including their gender, age, medical histories, diseases, symptoms, and any other relevant medical information. User profile records can also include information regarding finances, products and services enrolled in, and goods previously purchased. In an embodiment of the present invention, user profile records are created by asking the user a series of questions. The responses are used to build the user's profile. In an embodiment of the present invention, the responses to targeted questions can be entered by a health care professional or by the user themselves from an external source. In an embodiment of the present invention, a user profile is obtained from an external source.

In an embodiment of the present invention, the user profile is built by using personal information for the user received from an external source. The personal information includes medical records, social services records, and publically available records. The personal information can be used to answer the series of questions to build the user profile, which can then be stored on the server or elsewhere on the network.

In a preferred embodiment of the invention, user profile records 138 do not contain the user's name, but instead only contain the user's ID number. In other words, the user's medical information is kept separate from the user's identifying information. This maintains the user's medical privacy and anonymity. As will be described in more detail with respect to FIG. 2, every patient is assigned a user ID number. The user's name and identifying information is stored in the user's registration record 140 along with the user's ID number. The user's medical information is stored in a user profile record 138 along with the user's user ID number. In this way, the user's profile record 138 can be sent to a third party without revealing the user's identity to the third party. In this way, EmergingMed.com has access to the user's identifying information, but third parties do not. Additional records can be added to database 142 for various other purposes. Also, the organization of the records shown in FIG. 1 is by example only, and different organizations and groupings of records is possible.

FIG. 2 depicts a flowchart illustrating a method of matching a patient with available clinical trials. However, while the steps of FIG. 2 are directed to matching a patient with available clinical trials, the steps generally apply to performing matching between users and service providers. In step 200, a user registers with the EmergingMed.com web site. The user could be a patient, a health care professional such as a doctor, a representative from a clinical trial sponsor, an investigator, a representative from a health care facility or clinical trial site, or any other individual or entity involved in the clinical trial process.

When a user registers, the user selects a user name and a password. The user can also submit an e-mail address. This information is stored in a user registration record 140. The user is also assigned a user ID number. This user ID number is attached to the user's profile records/medical information in order to keep the user-patient's identity anonymous.

In step 201, a user interested in searching for available clinical trials accesses the EmergingMed.com web site by entering an appropriate URL such as http://www.emergingmed.com. The user then clicks on a link or a series of links that directs the user to the clinical trial search process. In an embodiment of the present invention, a product and services search process is made available to the user.

One type of user that might be interested in searching for an available clinical trial is simply a patient or a relative or friend of a patient. The user could also be a health care professional such as the patient's doctor.

In the FIG. 2 embodiment of the present invention, the first step in finding appropriate clinical trials is creating a user profile. In an embodiment of the present invention, the profile is a patient profile that will contain the patient's medical information and any of the patient's characteristics that would be useful in determining whether a patient were suitable for a particular clinical trial.

In the FIG. 2 embodiment of the present invention, the patient profile is created by asking the user a first series of questions, which can be dynamic, based on a user's specific needs or problem, such as disease and sub-disease, and a second series of questions that are specific to a specific program, such as a clinical trial. In step 202, the user is asked a first series of questions. Static questions are a series of pre-defined questions that are asked about every patient. Examples of static questions include name of disease, name of sub-disease, smoker (yes/no), willing to travel (yes/no), and any other pertinent medical or patient information. The user can select a disease and sub-disease from a set of menus. For example, the user could select the disease “cancer” and the sub-disease “skin cancer.” Optionally, the user can select the types of trials for which he or she is interested. For example, the user can select the trial sponsor type, trial modality, trial type of study, and drug or compound name.

Note that the “user” is not necessarily the “patient.” As an example, a patient's doctor could be the “user” who accesses EmergingMed.com. In an embodiment of the present invention, the patient's doctor enters information about the patient in response to the first and second series of questions to build the user profile. Using this example, the patient's doctor is doing the searching for clinical trials on behalf of the patient. In step 204, the user is asked a second series of of questions that are specific to the service program. The second series of questions are questions which are selected based on the user's previous answers to other questions.

In an embodiment of the present invention, when the user is presented with questions, the user is also presented with a group of answer options. The user can click on one or more of the answer options to respond to the question (some questions only allow one answer option to be selected, whereas other questions allow multiple answer options to be selected).

In an embodiment of the present invention, the questions asked to the patient, and the answer options provided to the patient, are such that a computer software program can evaluate and score the answers to the questions, rather than having a human being evaluate the answers. For example, one type of question that is easy to evaluate and/or score by a computer program is a question that allows the patient to choose one or more answers from a set of discrete multiple-choice answers. This type of question is very easy for a computer to evaluate and/or assign a score. As another example, if the patient is required to enter a numerical number, such as enter the patient's blood pressure, height or weight, this is also very easy for a computer to evaluate and/or assign a score.

In an embodiment of the present invention, the questions and answers to questions can be presented in a natural language format, such as “Please describe your pain” and then the patient would be allowed to enter a text message. Processing to evaluate the natural response is provided using natural language processing to provide meaning to known technical terms. In an embodiment of the present invention, the natural language format is reviewed and the evaluation uploaded and stored to the system.

Some example questions are presented as follows:
Please select any or all prior cancer treatments (followed by a list of treatments, patients can click on any treatments they have had).
How many times did you have surgery?
Please select all dates that correspond to your surgeries (followed by a list of dates that the patient can click on).
Select all surgical procedures performed to date.
Was your surgery followed by (followed by a list of choices)?
Was your surgery proceeded by (followed by a list of choices)?
How many chemotherapy regimes have you received?
Please select all dates that correspond to your chemotreatment.
Which organs are affected by malignancies at this time?
What is the stage of cancer at the time of diagnosis?

The user can be asked different levels of dynamic questions. For example, depending on the user's answer to a particular question, the user can be asked a follow-up dynamic question. If the user answers this question in a certain way, the user can be asked another follow-up question to the follow-up question. In this way the user is automatically steered through the process of building a patient profile. As an example, if the user selects “Lung Cancer” as a disease, the user could be asked “Are you a smoker?”If the user selects “YES”, then the user could be asked: “How many cigarettes a day do you smoke?” If the user selects “More than five”, then the user could be asked “How many years have you smoked?” In this way the user is steered through the process of building a patient profile.

As the questions are answered, static and dynamic, a patient profile is developed. In an embodiment of the present invention, the user may save the responses to the static and/or dynamic questions. In an embodiment of the present invention, the user can save the user profile for later use, verification and editing. In patient profile records 138 in database 142. In an embodiment of the present invention, the user profile received from the external source is based on responses to the static and dynamic questions. In an embodiment of the present invention, the user profile is received from an external source. In an embodiment of the present invention, the user profile received from the external source is based on responses to the static and dynamic questions. In an embodiment of the present invention, the questions and answers to create the user profile can be provided telephonically and transformed into data capable of being stored on a recordable storage medium.

In step 206, EmergingMed.com server 102 begins a process of determining whether the patient's profile matches any available ongoing clinical trials by comparing the patient's profile with acceptance criteria for available on-going clinical trials.

As explained previously, in an embodiment of the present invention, the answers requested from the users are suitable for a computer software program to score and evaluate. Thus, a computer program process can automatically determine whether the patient prequalifies.

In step 208, the system makes a preliminary determination of whether the patient qualifies for any available on-going, service programs, such as clinical trials.

One method that can be used to determine whether a patient prequalifies for a particular trial site, is that the patient prequalifies for a trial site only if the patient meets all of the acceptance criteria for that specific trial. For example, a trial site could require that a patient must be female between the ages of 30-40 who has breast cancer, does not drink alcohol, and lives within twenty five miles of New York City. If the patient meets all of these criteria, then the patient will be prequalified for that trial site.

An alternative method of prequalifying patients is to calculate a score based on the answers given by the patient. For example, the score could simply be the number of criteria met by the patient. More complicated algorithms could also be used to generate a score. For example, the score could include the patient's blood pressure divided by two, plus three times the patient's age, and so on. The patient would then qualify only if the score exceeded or was less than a predetermined threshold or within certain predetermined threshold limits. There can also exist a combination of a score threshhold, and criteria which must be satisfied in order to qualify. For example, in order to qualify for a particular trial site, patients could be required to be female, over 35, and have a score over 253 where the score is based on a number of other factors.

Some examples of acceptance criteria that can be used include: the patient must be within a certain age range, must be female, must live within a certain geographic region, must have skin cancer, must have not had previous surgery, must have been diagnosed with cancer within the last six months, cancer must not have spread to other body organs, etc.

As mentioned previously, the users are required to enter answers to patient profile questions or information pertaining to the user is obtained from an external source. Optionally, the user could be provided with a combination of questions: some questions requiring answers in numerical or multiple choice format, and some questions requiring a text description to be entered by the user. The former type of questions are used to perform the automatic prequalification of the patient. The descriptive answers entered by the patient could later be sent to the clinical trial site for evaluation by clinical trial site personnel or processed automatically through natural language processing.

In an embodiment of the present invention, acceptance criteria for clinical trial sites are typically received from an external source. In an embodiment of the present invention acceptance criteria can be provided by the clinical trial sponsors. In another embodiment of the present invention, the acceptance criteria could also be provided by clinical trial site investigators. In another embodiment of the invention, the acceptance criteria can be obtained from a third party recordable storage medium. One method of providing acceptance criteria to EmerginMed.com is to have the clinical trial sponsor or clinical trial investigator provide acceptance criteria to server administration personnel at EmergingMed.com. The method for receiving acceptance criteria includes, but is not limited to, regular mail, fax, e-mail, telephonically, download over a wired or wireless communications medium, or any other communication method. The EmergingMed.com server administration personnel then program EmergingMed.com server 102 to use the acceptance criteria to qualify patients for that particular clinical trial.

An alternative method is to allow clinical trial sponsors and/or clinical trial investigators to be provided with access privileges to the EmergingMed.com server 102. The sponsors or investigators could then access the EmergingMed.com web site via network 116. A link or group of links would direct the sponsors or investigators to a web page that allows the sponsors/investigators to automatically enter acceptance criteria. Database 142 is scaleable and updateable by EmergingMed.com 102 personnel. In some instances, other parties such as clinical trial sponsors and investigators can be given access privileges (as described above) to enter data such as acceptance criteria, questions, answers, etc. The static and dynamic questions asked to patients to build their patient profile can be updated and/or supplemented frequently to reflect new medical developments, trial site selection criteria, new clinical trials, amendments to clinical trial protocols, and other developments.

Users can also be informed of the number of trials for their disease for which the patient does not qualify, or how many trials are currently closed, or potentially if there is a waiting list available for which the patients can sign up. For example, the user could be informed that for skin cancer there are currently ten trials available and the patient qualifies for three of those ten.

After the system has made a preliminary determination of whether the patient prequalifies for any clinical trials, in step 210 the system can provide targeted questions specific to each clinical trial for which the patient has preliminarily qualified. Once the system has received responses to these targeted questions, then in step 212 the system makes a final determination as to whether the patient prequalifies for any of the clinical trials based on the user's responses to the targeted questions.

In step 214, if the patient prequalifies for any clinical trials, the patient is then provided with an application to fill out to authorize further follow-up. The patient's applications are reviewed by EmergingMed. In response to receiving the application the user will be contacted via phone, email, mail, or fax and provided with information regarding the respective trial, and contact information or instructions for contacting the trial site (via phone or email/mail/fax). Another feature provided by EmergingMed.com server 102 is to allow users to search and obtain medical information about diseases, drugs, medical devices, treatments, clinical trials, and any other pertinent information. In this way, patients and health care professionals can educate themselves about a disease, standard or experimental treatments, and ongoing clinical trials before deciding whether to participate in any clinical trials. In an embodiment of the present invention, permission tracking is performed to ensure that the medical information provided has been approved for disclosure by EmergingMed. This process is enhanced by providing many links between the various records shown in database 142 in FIG. 1.

The method just described and shown in FIG. 2 is a method of matching patients with clinical trial sites. The system of the present invention can also perform other types of matching such as:
user to user matching
service provider to service provider matching
provider to user matching
user to provider matching
site to user matching
site to service provider matching

For example a user to user matching, such as patient to patient matching, involves matching one patient with another patient based on their patient profiles. For example, a patient with a particular disease could be matched with other patients with a similar disease. This allows the patients to automatically form a support group. A patient could be provided e-mail addresses of other matching patients so that they can be contacted. Each patient could be provided with an anonymous e-mail name so that the patient privacy can be protected. Alternatively, messages could be addressed to a user ID number.

Trial sponsor to investigator matching involves matching a clinical trial sponsor with an investigator suitable for conducting the trial. For example, a drug company might be interested in finding a researcher with 20 years of experience researching breast cancer treatment in the Milwaukee area. Investigator to trial site matching involves matching investigators with trial sites that are looking for investigators with particular qualifications. What all of these methods share in common is that the EmergingMed.com server 102 finds matches between matching parties and performs an initial layer of prequalification or prescreening before bringing the parties together.

FIG. 3 depicts a block diagram illustrating some exemplary links between various records in data storage device 120. These links allow a user to navigate the web site and efficiently find medical information relevant to their particular medical condition. The user can also search for relevant information by entering keyword queries. For example, a user searching for particular information about a particular disease would enter the name of a disease and sub-disease such as “cancer/skin cancer.” This would retrieve disease/sub-disease record 300 for skin cancer. Disease/sub-disease record 300 would contain information about skin cancer which would be provided to the user. When the user accesses disease/subdisease record 300, the user is provided with all of the information contained in record 300 as well as links to records 302, 304, 305, and 306. The user can then click on one of these links to access the linked record.

Disease/sub-disease record 300 contains links to related drug/device records 302. These drug/device records are associated with drugs and medical devices used to treat the disease/sub-disease associated with disease/sub-disease record 300. The drug/device records 302 contain information about their associated drug or device such as instructions for taking a drug or using a medical device, warnings, side effects, and similar information.

Disease/sub-disease record 300 also contains links to content records 304. Content records 304 contain additional information about the disease/sub-disease such as related news and journal articles, standard therapies, therapies in development, case studies, alternative treatments, and frequently asked questions.

Disease/sub-disease records 300 also contain links to clinical trial records 304. Clinical trial records 304 contain information about various clinical trials which address the specific disease/sub-disease such as the clinical trial sponsor type, trial site locations, acceptance criteria, number of people admitted, and so on. Disease/sub-disease records 300 also contain links to related question records 306. These are questions that are asked to users who are seeking to qualify for clinical trials. These questions are asked in step 204 in FIG. 2.

FIG. 3B shows another set of links emanating from drug or device record 308. A user can access a drug or device record 308 to find out information about that drug or device. The user will be presented with links to related content records 312 which provide content related to that drug or device. The user will also be presented with links to related clinical trial records 314. The user will also be presented with links to related disease/sub-diseases records 316.

FIG. 3C shows another set of links emanating from content record 318. Content record 318 could be a news or journal article, or some other piece of information. Content record 318 contains links to related drug records 320, related clinical trial records 322, and related disease/sub-disease records 324.

FIG. 3D depicts another set of links emanating from clinical trial record 326. Clinical trial record 326 contains links to related drug records 328, related content records 330, and related disease/subdisease records 332. Clinical trial record 326 also contains links to related question records 334. These questions are asked to users in step 210 of FIG. 2 to determine if they qualify for the specific clinical trial.

Another method of the present invention is to allow third party web sites to perform the trial matching and prequalification of the present invention. For example, suppose a drug company has its own web site: www.DrugCompany.com. DrugCompany.com has a contract with EmergingMed.com to allow users of DrugCompany.com to perform trial matching and prequalification.

When a user visits DrugCompany.com, the user is provided with a link or group of links which allows the user to search for clinical trials. There are various methods that can be used to allow DrugCompany.com to interface with EmergingMed.com server 102. In a first method, the DrugCompany.com server relays all of the data entered by the user to the EmergingMed.com server 102. The DrugCompany.com server then receives the data sent by EmergingMed.com server 102 and forwards it to the patient. DrugCompany.com thus acts as an intermediary or proxy server for the EmergingMed.com server. Another method is to provide DrugCompany.com with all of the software necessary to ask the patient's questions to build a patient profile. DrugCompany.com could then relay the information to EmergingMed.com server 102. EmergingMed.com server 102 could search database 124 and forward the results to DrugCompany.com. Another method allows DrugCompany.com to embed the EmergingMed.com software within their web application, allowing DrugCompany.com to have the features EmergingMed.com provides without having to relay data to or receive data from the EmergingMed.com server 102. A variety of other well known methods could be used to access EmergingMed.com server 102 via DrugCompany.com.

A patient who performs trial matching and prequalification at DrugCompany.com can also be limited to searching only subsets of the total available clinical trial sites. For example, the users at DrugCompany.com could be limited to only searching for clinical trials sponsored by DrugCompany.com.

In an embodiment of the present invention, a service provider, such as a trial sponsor is provided access to information stored for the service provider related to their services offered for verification of information accuracy.

In an embodiment of the present invention, streaming of information related to a service provider is provided.

Although the present invention has been described in terms of various embodiments, it is not intended that the invention be limited to these embodiments. Modification within the spirit of the invention will be apparent to those skilled in the art. The scope of the present invention is defined by the claims that follow.

What I claim is:

1. A method of matching a user with service providers, at least one program offered by a service provider, and/or a program site for a program comprising
receiving, at a server, acceptance criteria pertaining to the service provided by the service provider and a series of targeted questions targeted to the service;
comparing a user's profile with the acceptance criteria specifically developed for the program offered by the service provider or a group of service providers;
determining whether the user prequalifies for any of the programs offered by the service provider or a group of service providers;
notifying the user or the service provider when the user has prequalified for any of the programs offered by the service provider or a group of service providers clinical trials; and
providing the user with an application to authorize further follow-up in connection with the any of the programs offered by the service provider or a group of service providers

2. The method according to claim 1, wherein a program includes a system of projects or services intended to meet a need, a product, procedure evaluation and test.

3. The method according to claim 2, further comprising developing the user's profile by asking the user questions and then building the user's profile based on the user's responses to the questions,

4. The method according to claim 3, wherein the user's profile is stored on the server.

5. The method according to claim 3, wherein the questions include a first series of questions based on the user's needs or problem and a second series of questions based on the user's response to the first series of questions and directed to one or more service providers, at least one program offered by the one or more providers and/or a program site for an offered program after determining that the user meets the preliminary acceptance criteria for the one or more service providers, at least one program offered by the one or more providers and/or a program site for an offered program.

6. The method according to claim 3, wherein the user's profile is built by using personal information for the user received from and external source.

7. The method according to claim 6, wherein the personal information includes medical records, social services records, and/or publically available records and the personal information can be used to answer the series of questions to build the user profile.

8. The method according to claim 1, wherein service providers include trial sponsors, clinical trial investigators, financial assistance providers, case management providers, and social assistance providers.

9. The method according to claim 1, wherein the user includes a patient, an individual in need of program assistance, family member, and doctor.

10. The method according to claim 1, wherein the acceptance criteria and the targeted questions can be received from an external source using a wired or wireless connection.

11. The method according to claim 10, wherein the acceptance criteria are received from an external source using a wired or wireless connection.

12. The method according to claim 11, wherein the external source includes a database, a system of the service provider or a system of a third party that received acceptance criteria from a service provide.

13. The method of claim 1, the service provider includes a trial sponsor, investigator, financials services provider and the provider of any other service.

14. The method of claim 1, wherein the service program includes clinical trials for new drugs, medical devices, or treatments to treat their disease and financial services for new financial instruments, products and services or any other service or product provided by a service provider.

15. The method according to claim 1, further comprising receiving authorization for additional follow-up from the user.

16. The method according to claim 15, further comprising providing the user with contact information for the service provider.
